(19) United States
(12) Patent Application Publication
(10) Pub. No.: US 2006/0185699 A1
(43) Pub. Date: Aug. 24, 2006

(54) Dishwasher, and door hinge for the same

(75) Inventors: Hae Deog Jeong, Changwon-si (KR); Byung Hwan Ahn, Gimhae-si (KR); Hung Myong Cho, Gimhae-si (KR); Sang Woo Woo, Changwon-si (KR); Jong Chul Bang, Changwon-si (KR)

Correspondence Address: MCKENNA LONG & ALDRIDGE LLP, 1900 K STREET, NW, WASHINGTON, DC, 20006, US

(73) Assignee: LG ELECTRONICS, INC., Youngsungpo-gu (KR)

(21) Appl. No.: 11/337,796

(22) Filed: Jan. 24, 2006

(30) Foreign Application Priority Data
Jan. 25, 2005 (KR) 10-2005-006641

(51) Int. Cl. B08B 3/02

(52) U.S. Cl. 134/184; 134/200; 134/201

(57) ABSTRACT

A dishwasher and a door hinge thereof are provided. The dishwasher and the door hinge include a door cover support plate that aligns a position of a door cover during assembly of the door cover and a door liner.

### BACKGROUND OF THE INVENTION

1. Field of the Invention

The present invention relates to a dishwasher, and more particularly, to a dishwasher and a door hinge that allow easy coupling of a door cover and a door liner that form a door.

2. Description of the Related Art

A dishwasher is a home appliance that sprays high-pressure wash liquid through spray nozzles to wash and remove food residue left on surfaces of dishes. Specifically, a dishwasher includes a tub forming a wash compartment, and a sump installed at the bottom of the tub for storing wash liquid. Installed inside the sump is a wash pump that pumps wash liquid to the spray nozzles. The wash liquid pumped to the spray nozzles is discharged under high pressure through spray holes at the ends of the nozzles. The high-pressure wash liquid spray collides with the surfaces of dishes, so that food residue and other impurities on the dishes fall to the floor of the tub.

A door, that opens and closes the front of the dishwasher tub, includes a door liner and a door cover installed in front of the door liner to enhance the outward appearance of the dishwasher. The door is coupled to a door hinge installed at the side of the tub to open and close the tub.

However, the fastening structure of the door according to the related art lacks a portion that guides the insertion of the door cover during the process of assembling the door cover to the front portion of the door liner. Therefore, the door cover and the door liner can be improperly aligned. That is, the upper portion of the door liner and that of the door cover do not align with each other, or the sides of the door liner and the door cover do not accurately align. Accordingly, the process of accurately aligning the door cover with the front of the door liner during assembly is time-consuming, and a lot of manpower is wasted by assembly workers fitting door covers to door liners by hand.

### SUMMARY OF THE INVENTION

Accordingly, the present invention is directed to a dishwasher and a door hinge that substantially obviate one or more problems due to limitations and disadvantages of the related art.

An object of the present invention is to provide a dishwasher and a door hinge that allow easy assembly of a door cover and a door liner.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided dishwasher including: a tub frame; a door liner pivotably installed for opening and closing an inside of the tub frame; a door hinge coupled at a respective end of the tub frame and the door liner, the door hinge being a pivoting axis of the door liner; a door cover coupled to the door liner; and a door cover support plate for aligning a position of the door cover during an assembly of the door cover and the door liner.

In another aspect of the present invention, there is provided a door hinge of a dishwasher coupled to an end of a door including a door cover and a door liner and an end of a tub, the door hinge being an axis of rotation for the door when the tub is opened and closed, wherein the door hinge includes: a hinge body; a hinge arm extending a predetermined distance from an end of the hinge body; a front support plate bent from a side of the hinge body and contacting a front portion of the door liner; a side support plate bent from the front support plate and contacting a side of the door liner; and a door cover support plate formed on the hinge body for aligning a position of the door cover during an assembly of the door cover and the door liner.

In a further aspect of the present invention, there is provided a door hinge of a dishwasher coupled to an end of a door including a door cover and a door liner and an end of a tub, the door hinge being an axis of rotation for the door when the tub is opened and closed, wherein the door hinge includes: a hinge body; and a door cover support plate formed on the hinge body for aligning a position of the door cover during an assembly of the door cover and the door liner.

The dishwasher and the door hinge according to the present invention allow a much easier assembly of a door cover (forming the front of a door) and a door liner by smoothly inserting the door cover along and into the door liner.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a sectional side view of a dishwasher according to the present invention;

FIG. 2 is a perspective view of a door cover according to the present invention;

FIG. 3 is a perspective view of a door hinge according to the present invention; and

FIG. 4 is a perspective view showing the assembling of a door cover and a door hinge according to the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

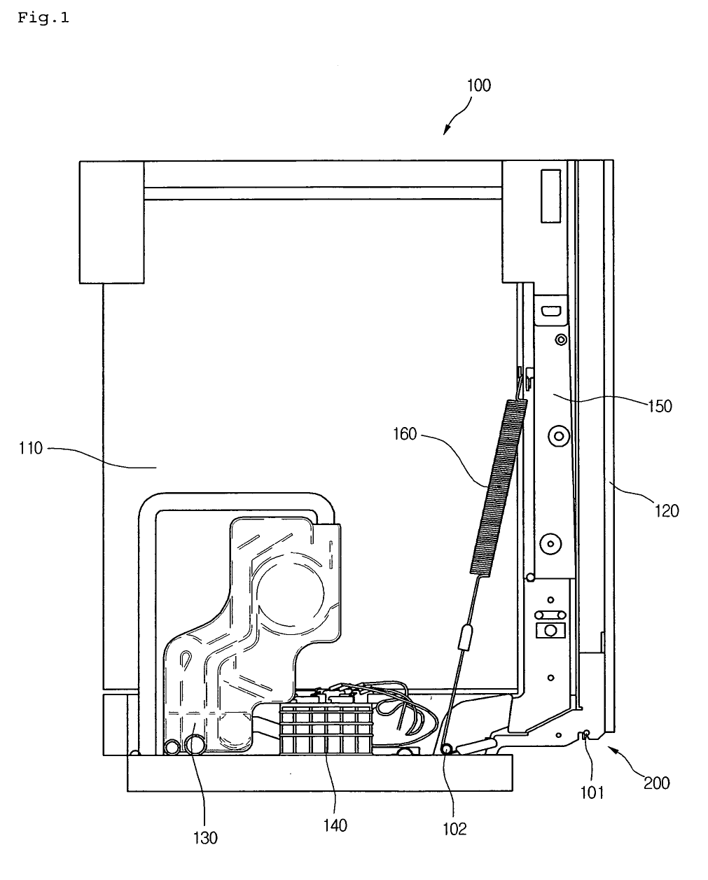

FIG. 1 is a sectional side view of a dishwasher according to the present invention.

Referring to FIG. 1, a dishwasher 100 according to the present invention includes a tub 110, a tub frame 150, a door hinge 200, a spring 160, a door liner 120, an air brake 130, and a water level sensor 140.

The tub 110 forms a wash compartment within for holding wash liquid. The tub frame 150 is installed at the front periphery of the tub 110 to retain the shape of the tub 110. The door hinge 200 is installed at the bottom of the tub frame 150, with the door coupled at its upper end. The door hinge 200 pivots centrally around a hinge inserted into the side of the tub frame 150. One end of the spring 160 is connected to one end of the door hinge 200, and the other end of the spring 160 is coupled to an end of the door frame so that the spring expands. The door liner 120 is fastened to the other end portion of the door hinge 200 to open and close the front of the tub 110. The door cover 170 (to be described below) is installed at the front of the door liner 120. The air brake 130 is installed on the side of the tub 110, and forms passages for wash liquid to flow through. The water level sensor 140 allows wash liquid that enters the air brake 130 to enter the tub 110, and senses the water level inside the tub 110.

In the above-structured dishwasher, in order to open the door, a user grasps the door and pulls in a forward direction, so that the door hinge 200 rotates in a clockwise direction (in FIG. 1). The spring 160 connected to the end of the hinge 200 contracts. In reverse, when the user closes the door, the door hinge 200 rotates in a counter-clockwise direction, so that the spring 160 expands. The elasticity of the spring 160 prompts the door to return to a closed position from an open position when a user lets go of it.

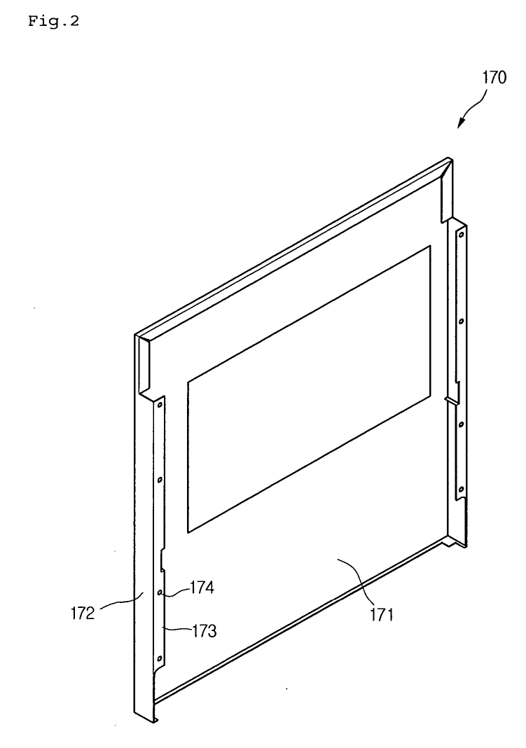

FIG. 2 is a perspective view of a door cover according to the present invention.

Referring to FIG. 2, the door cover 170 according to the present invention is roughly square in shape and is installed at the front of the door liner 120.

Both sides of the front portion 171 of the door cover 170 are bent, so that the ends of the door cover 170 are “u”-shaped. Specifically, both sides of the door cover 170 are bent at right angles to form a bent portion 172. A further right angle bend inward at the end of the bent portion 172 forms a sliding portion 173. The sliding portion 173 may be parallel with the front of the door cover 170. A fastening hole 174 is formed in the sliding portion 173 for inserting a predetermined fastening member therethrough.

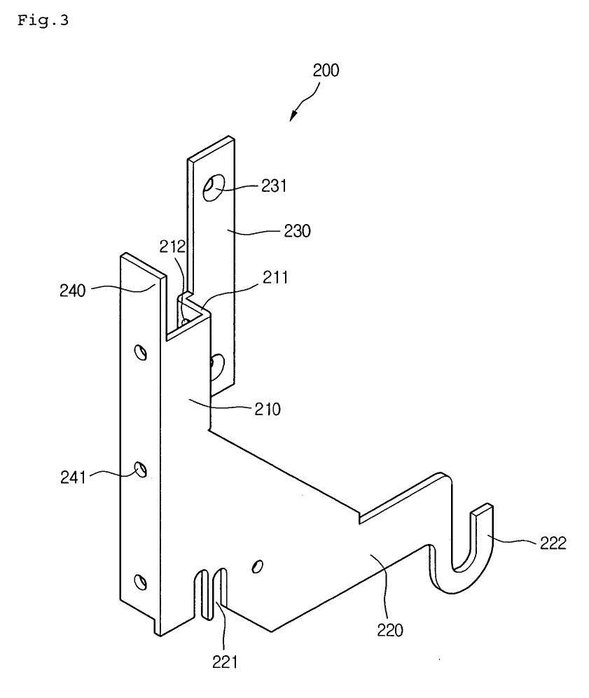

In order to couple the front portion of the door liner 120 to the door cover 170, a door cover support panel (240 in FIG. 3) is inserted between the sliding portion 173 and the front portion 171. The door cover support panel 240 is formed on the door hinge 200.

The process of coupling the door cover 170 to the door liner 120 will now be described with reference to the diagrams.

FIG. 3 is a perspective view of a door hinge according to the present invention.

Referring to FIG. 3, the door hinge 200 according to the present invention may be made of a metal material having a predetermined hardness.

The door hinge 200 includes a hinge body 210, a hinge arm 220, a front support plate 211, a side support plate 230, a spring hook 222, and a door cover support plate 240.

The hinge arm 220 extends a predetermined distance from the lower end of the hinge body 210. A “u”-shaped spring hook 222 is formed at the end of the hinge arm 220. The spring hook 222 couples to one end of the spring 160.

The front support plate 211 bends at a right angle from an end of the hinge body 210. The front portion of the door liner 120 is adhered to the front support plate 211. At least one fastening hole 212 is formed on the front support plate 211.

The side support plate 230 is bent once again from the front support plate 211. The side support plate 230 is adhered to the side of the door liner 120. A door liner fastening hole 231 is formed on the side support plate 230. A predetermined fastening member is coupled to the door liner fastening hole 231 to couple the side support plate 230 to the door liner 120.

The hinge arm 220 has a pivoting slot 221 formed thereon that can catch and pivot on a hinge 101. The hinge 101 formed on the tub frame 150 catches on the pivoting slot 221. Thus, the door hinge 200 and the door can pivot on the axis of the hinge 101.

The door cover support plate 240 is bent at an end of the hinge body 210, the end of the bent portion extends a predetermined distance upwards. Therefore, the end of the door cover support plate 240 protrudes a predetermined length from the hinge body 210. The door cover support plate 240 is formed on an end of the hinge body 210 other than that on which the hinge arm 220 is formed. This door cover support plate 240 allows for a smooth assembly of the door cover 170, which will be described below. A door cover fastening hole 241 is formed on the curved extension of the hinge body 210 that is the door cover support plate 240.

In door hinge 200 is coupled so that it can pivot at both lower ends of the tub frame 150.

In further detail, the door cover support plate 240 moves in a forward direction of the dishwasher 100, and the side support plate 230 presses against the sides of the door liner 120, as the door hinge 200 is installed on the tub frame 150. Here, the pivoting slot 221 of the door hinge 200 catches on the hinge 101 of the tub frame 150. Then, the door hinge 200 rotates on the axis of the hinge 101 with respect to the tub frame 150.

In this state, one end of the spring 160 couples to the spring hook 222. The end of the spring 160 catches on the spring hook 222 through the pulley 102. Then, the door hinge 200 is pulled by the spring 160, so that the door hinge 200 is pressed and retained against the tub frame 150.

When the door liner 120 is pressed against the door hinge 200, bolts or other fastening members are coupled to the door liner fastening hole 231/the fastening hole 212, and the opposite fastening holes of the door liner 120. In this way, the door liner 120 and the door hinge 200 are fastened.

Here, the inner surface of the front portion of the door cover 170 presses against the front portion of the door cover support plate 240 and slides, so that the door hinge 200 easily inserts into the door cover 170. This process is described further below.

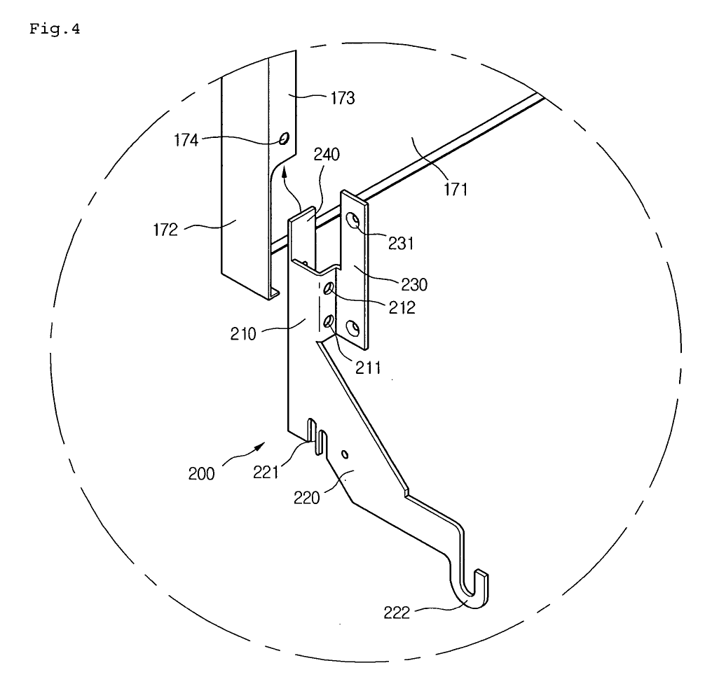

FIG. 4 is a perspective view showing the assembling of a door cover and a door hinge according to the present invention.

Referring to FIG. 4, the inside of the front portion 171 of the door cover 170 contacts the front portion of the door cover support plate 240 and slides, so that the door cover 170 is inserted. Furthermore, the outer surface of he hinge body 210 contacts the inner surface of the curved portion bent portion 172 and slides downward. Also, the lower portion of the door cover 170 slides up to the lower portion of the door hinge 200, whereupon a bolt or other fastening member is passed through the fastening hole 174 formed in the sliding portion 173 of the door cover 170 and the door cover fastening hole 241 of the door cover support plate 240. Then, the door cover 170 and the door hinge 200 are fastened.

The above assembly process, a user does not have to manipulate the door cover 170 to precisely align the fastening hole formed in the door cover 170 with the fastening hole formed in the door liner 120. Accordingly, the assembling time required to couple the door cover 170 is substantially reduced.

The dishwasher, and the door hinge according to the present invention allows the door cover formed at the front of the door to be inserted by sliding along the door liner, to greatly simplify the assembling process.

What is claimed is:

1. A dishwasher comprising:
a tub frame;
a door liner pivotably installed for opening and closing an inside of the tub frame;
a door hinge coupled at a respective end of the tub frame and the door liner, the door hinge being a pivoting axis of the door liner;
a door cover coupled to the door liner; and
a door cover support plate for aligning a position of the door cover during an assembly of the door cover and the door liner.

2. The dishwasher according to claim 1, wherein the door cover support plate is formed on the door hinge.

3. The dishwasher according to claim 1, wherein the door cover support plate slides along the door cover during an assembly of the door cover and the door hinge.

4. The dishwasher according to claim 1, wherein the door cover support plate is made of metal.

5. The dishwasher according to claim 1, wherein the door hinge includes:
a hinge body;
a hinge arm extending a predetermined length from a side of the hinge body;
a front support plate bent from a side of the hinge body and contacting a front portion of the door liner; and
a side support plate bent from a side of the front support plate and contacting a side of the door liner.

6. The dishwasher according to claim 5, wherein the door cover support plate is bent at a side of the hinge body opposite to a side of the hinge arm.

7. The dishwasher according to claim 5, wherein the side support plate has at least one fastening hole formed within.

8. The dishwasher according to claim 5, wherein the hinge arm has a spring hook formed at an end thereof for coupling to a spring.

9. The dishwasher according to claim 1, wherein the door cover support plate contacts an inner surface of a front portion of the door cover.

10. The dishwasher according to claim 1, wherein the door cover support plate has at least one fastening hole formed therein.

11. A door hinge of a dishwasher coupled to an end of a door including a door cover and a door liner and an end of a tub, the door hinge being an axis of rotation for the door when the tub is opened and closed, wherein the door hinge comprises:
a hinge body;
a hinge arm extending a predetermined distance from an end of the hinge body;
a front support plate bent from a side of the hinge body and contacting a front portion of the door liner;
a side support plate bent from the front support plate and contacting a side of the door liner; and
a door cover support plate formed on the hinge body for aligning a position of the door cover during an assembly of the door cover and the door liner.

12. The door hinge according to claim 11, wherein the door cover support plate slides along the door cover during a coupling of the door cover and the door hinge.

13. The door hinge according to claim 11, wherein the door cover support plate is made of metal.

14. The door hinge according to claim 11, wherein the door cover support plate bends at a side of the hinge body opposite to the hinge arm.

15. The door hinge according to claim 11, wherein the side support plate includes at least one fastening hole formed within.

16. The door hinge according to claim 11, wherein the hinge arm includes a spring hook formed at an end thereof for coupling to a spring.

17. The door hinge according to claim 11, wherein the door cover support plate contacts an inner surface of a front portion of the door cover.

18. The door hinge according to claim 11, wherein the door cover support plate includes at least one fastening hole formed therein.

19. A door hinge of a dishwasher coupled to an end of a door including a door cover and a door liner and an end of a tub, the door hinge being an axis of rotation for the door when the tub is opened and closed, wherein the door hinge comprises:
a hinge body; and
a door cover support plate formed on the hinge body for aligning a position of the door cover during an assembly of the door cover and the door liner.

20. The door hinge according to claim 19, wherein the door cover support plate slides along the door cover when the door cover and the door hinge are coupled.
